(19) United States
(12) Patent Application Publication
(10) Pub. No.: US 2026/0366915 A1
(43) Pub. Date: Nov. 19, 2026

(54) DEVICE AND SYSTEM

(71) Applicant: CANON KABUSHIKI KAISHA, Tokyo (JP)

(72) Inventor: AIHIKO NUMATA, Tokyo (JP)

(21) Appl. No.: 19/666,050

(22) Filed: May 1, 2026

(30) Foreign Application Priority Data
May 15, 2025 (JP) 2025-081727

(51) Int. Cl. G01J 1/44

(52) U.S. Cl. CPC G01J 1/44; G01J 2001/4466

(57) ABSTRACT

A device includes a conversion unit that generates a detection signal by avalanche multiplication, an exposure period for one frame including a plurality of detection periods that output a signal based on the detection signal, each detection period including a first period and a second period, the second period being a period that is subsequent to the first period and does not overlap the first period, a count circuit that counts first signals based on the detection signal during the first period and counts second signals based on the detection signal during the second period, at least one memory storing instructions, and at least one processor executing the stored instructions to determine non-uniformity of photons incident on the conversion unit based on a distribution of count values of the first and second signals.

### BACKGROUND

### FIELD OF THE TECHNOLOGY

The aspect of the embodiment relates to a device and a system.

### DESCRIPTION OF THE RELATED ART

A photoelectric conversion device is known that is configured to detect very weak light of a single photon level by utilizing avalanche multiplication. Japanese Patent Laid-Open No. 2020-123847 describes a technique for detecting the number of times of occurrence of avalanche multiplication by controlling a timing of recharging an avalanche photodiode (APD) by using a pulse signal.

A photoelectric conversion device described in Japanese Patent Laid-Open No. 2020-123847 can detect only one photon per pulse signal. Accordingly, when two or more photons are incident between one pulse signal and another pulse signal subsequent to the one pulse signal, only the first photon can be detected and thus omissions occur in counting the number of photons. However, it is known that if typically constant light is captured, adverse effects of omissions in counting can be corrected by statistically predicting the number of photons incident during one cycle of a pulse signal.

According to the technique described in Japanese Patent Laid-Open No. 2020-123847, the accuracy of processing of correcting omissions in counting on a light source such as a light emitting diode (LED) light source whose brightness periodically changes with time deteriorates. In order to appropriately correct omissions in counting, it is necessary to determine whether a distribution of photons incident during an exposure period is uniform like in the case of constant light, or whether the distribution is not uniform like in the case of an LED light source.

### SUMMARY

A device includes a conversion unit configured to generate a detection signal by avalanche multiplication, an exposure period corresponding to one frame in the conversion unit including a plurality of detection periods for outputting a signal based on the detection signal, each of the plurality of detection periods including a first period and a second period, the second period being a period that is subsequent to the first period and does not overlap the first period, a count circuit configured to count first signals based on the detection signal during the first period and to count second signals based on the detection signal during the second period, at least one memory storing instructions, and at least one processor that executes the stored instructions that cause the at least one processor to determine non-uniformity of photons incident on the conversion unit based on a distribution of count values of the first signals counted during the first period and the second signals counted during the second period.

Features of the disclosure will become apparent from the following description of embodiments with reference to the attached drawings. The following description of embodiments is described by way of example.

### BRIEF DESCRIPTION OF THE DRAWINGS

FIG. 1 illustrates a configuration example of a photoelectric conversion device.

FIG. 2 illustrates a configuration example of a sensor substrate.

FIG. 3 illustrates a configuration example of a circuit board.

FIG. 4 is an equivalent circuit corresponding to a pixel of the photoelectric conversion device.

FIGS. 5A and 5B are timing diagrams of the photoelectric conversion device.

FIGS. 6A and 6B are timing diagrams of the photoelectric conversion device.

FIG. 7 is an equivalent circuit diagram illustrating a photoelectric conversion device according to a first embodiment.

FIGS. 8A and 8B are timing diagrams of the photoelectric conversion device according to the first embodiment.

FIGS. 9A and 9B are histograms each illustrating the number of counts.

FIG. 10 is an equivalent circuit diagram illustrating a photoelectric conversion device according to a second embodiment.

FIGS. 11A to 11D are timing diagrams of the photoelectric conversion device according to the second embodiment.

FIGS. 12A and 12B are histograms each illustrating the number of counts.

FIG. 13 is an equivalent circuit diagram illustrating a photoelectric conversion device according to a third embodiment.

FIG. 14 is an equivalent circuit diagram illustrating a photoelectric conversion device according to a fourth embodiment.

FIGS. 15A and 15B are timing diagrams of the photoelectric conversion device according to the fourth embodiment.

FIGS. 16A and 16B are histograms each illustrating the number of counts.

FIGS. 17A and 17B are timing diagrams of the photoelectric conversion device according to the fourth embodiment.

FIG. 18 is a block diagram illustrating a configuration example of a photoelectric conversion system.

### DESCRIPTION OF THE EMBODIMENTS

Embodiments of the disclosure will be described in detail below. The following embodiments are examples for implementing the disclosure and may be modified or adjusted as appropriate depending on configurations of devices and various conditions to which the disclosure is applied. The disclosure is not limited to the following embodiments. Throughout the drawings, components having the same functions are denoted by the same reference numerals and repeated descriptions thereof are omitted.

In the following description, an anode of an avalanche photodiode (APD) has a fixed potential, and a signal is taken from a cathode side. The disclosure can be established even in a case where the cathode of the APD has a fixed potential and a signal is taken out from the anode side. Although the following embodiments are described assuming that one of the nodes of the APD has a fixed potential, potentials at both nodes of the APD may vary.

### Configuration of Photoelectric Conversion Device

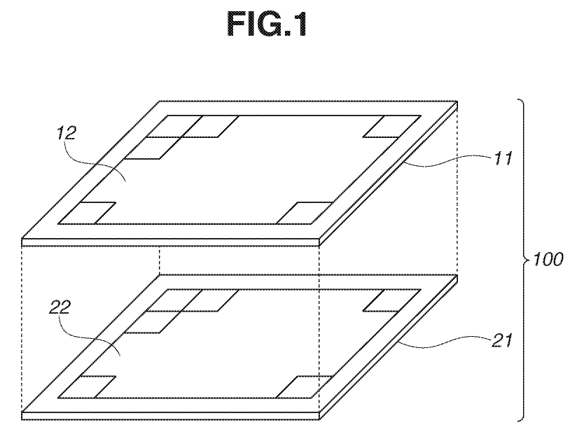

FIG. 1 illustrates a configuration example of a photoelectric conversion device according to an embodiment of the disclosure. A photoelectric conversion device 100 having a laminated structure in which two substrates, which are a sensor substrate 11 and a circuit board 21, are laminated and are electrically connected will be described below by way of example. However, the configuration for implementing the disclosure is not limited to the laminated structure, but instead may be a non-laminated structure in which components included in the sensor substrate 11 and components included in the circuit board 21 are arranged in a common semiconductor layer.

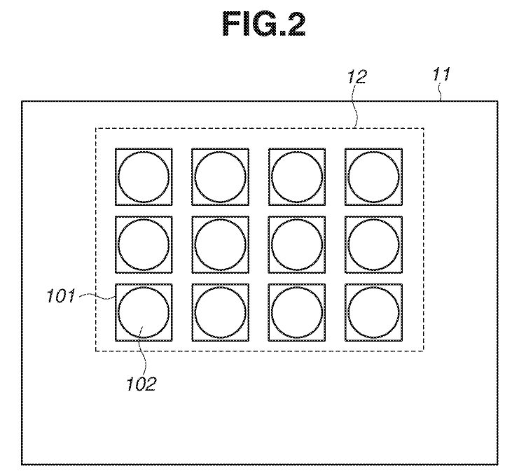

The sensor substrate 11 includes a pixel region 12, and the circuit board 21 includes a circuit region 22 in which signals detected in the pixel region 12 are processed. FIG. 2 illustrates a configuration example of the sensor substrate 11.

The pixel region 12 included in the sensor substrate 11 includes a plurality of pixels 101 that are two-dimensionally arranged in a plurality of rows and a plurality of columns. Each pixel 101 includes a photoelectric conversion unit 102 including an APD. The number of rows and the number of columns in a pixel array forming the pixel region 12 are not particularly limited.

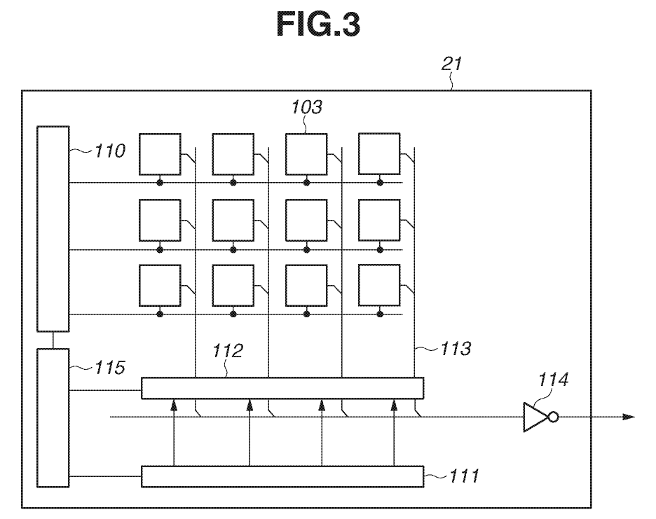

FIG. 3 illustrates a configuration example of the circuit board 21. The circuit board 21 includes signal processing circuits 103 that process electric charges photoelectrically converted by the photoelectric conversion unit 102 illustrated in FIG. 2, a readout circuit 112, a control pulse generation unit 115, a horizontal scanning circuit 111, signal lines 113, and a vertical scanning circuit 110. The vertical scanning circuit 110 receives a control pulse supplied from the control pulse generation unit 115, and supplies the control pulse to each pixel 101. The vertical scanning circuit 110 employs a logic circuit such as a shift register or an address decoder.

A signal output from the photoelectric conversion unit 102 in each pixel 101 is processed by the signal processing circuits 103. Each signal processing circuit 103 is provided with a counter, a memory, and the like. The memory holds digital values.

The horizontal scanning circuit 111 inputs a control pulse for sequentially selecting columns to the signal processing circuits 103 so as to read out signals from the memory in each pixel 101 in which the digital signal is held.

Signals output from the signal processing circuits 103 in the pixels 101 selected by the vertical scanning circuit 110 in the selected column are output to the signal lines 113. The signals output to the signal lines 113 are output to the outside of the photoelectric conversion device 100 through an output circuit 114.

As illustrated in FIGS. 2 and 3, a plurality of signal processing circuits 103 is arranged in a region overlapping the pixel region 12 in a planar view. The vertical scanning circuit 110, the horizontal scanning circuit 111, the readout circuit 112, the output circuit 114, and the control pulse generation unit 115 are arranged such that these circuits overlap each other in a region between an edge of the sensor substrate 11 and an edge of the pixel region 12 in a planar view. In other words, the sensor substrate 11 includes the pixel region 12 and a non-pixel region located in the vicinity of the pixel region 12. The vertical scanning circuit 110, the horizontal scanning circuit 111, the readout circuit 112, the output circuit 114, and the control pulse generation unit 115 are arranged in a region overlapping the non-pixel region in a planar view.

The arrangement of the signal lines 113 and the arrangement of the readout circuit 112 and the output circuit 114 are not limited to those illustrated in FIG. 3. For example, the signal lines 113 may be arranged to extend in a row direction, and the readout circuit 112 may be arranged at the ends of the extending signal lines 113. There is also no need to provide one signal processing unit function in each photoelectric conversion unit 102. One signal processing unit may be shared by a plurality of photoelectric conversion units 102 and may be configured to sequentially perform signal processing.

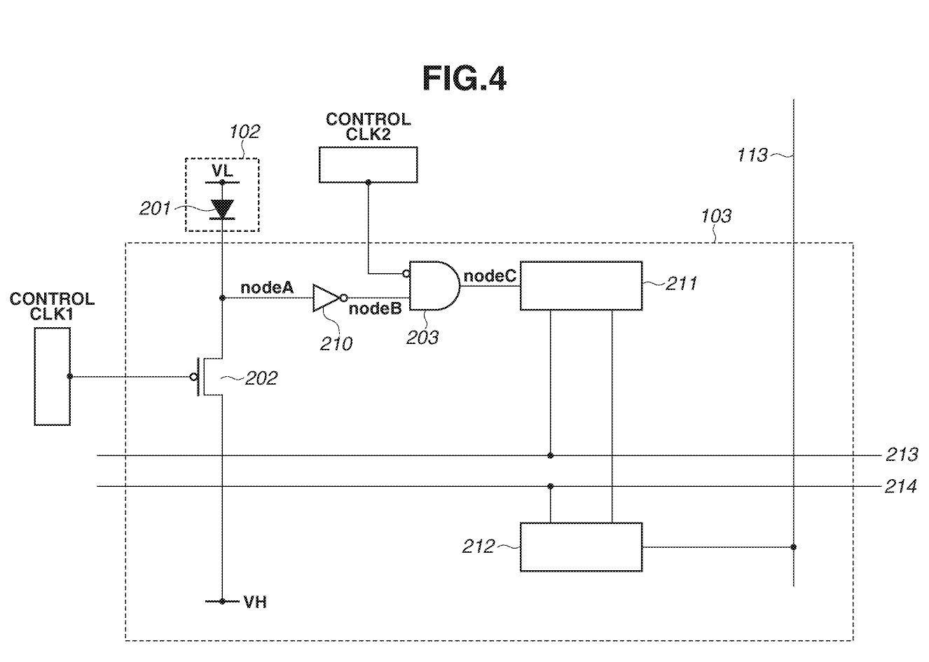

FIG. 4 is a diagram illustrating an equivalent circuit of the photoelectric conversion unit 102 and the signal processing circuit 103 corresponding to the photoelectric conversion unit 102 illustrated in FIGS. 2 and 3.

An APD 201 generates an electric charge pair according to incident light by photoelectric conversion. One of two nodes of the APD 201 is connected to a power supply line to which a drive voltage VL (first voltage) is supplied. The other of the two nodes of the APD 201 is connected to a power supply line to which a drive voltage VH (second voltage) that is higher than the drive voltage VL is supplied. In the configuration example illustrated in FIG. 4, one of the nodes of the APD 201 is an anode, and the other node of the APD 201 is a cathode.

The anode and the cathode of the APD 201 are supplied with a reverse bias voltage at which the APD 201 performs an avalanche multiplication operation. In a state where such a voltage is supplied, electric charges generated by incident light cause avalanche multiplication, so that avalanche multiplication current is generated.

In a case where a reverse bias voltage is supplied, there are two modes, that is, a Geiger mode in which an APD operates with a voltage difference between an anode voltage and a cathode voltage that is greater than a breakdown voltage, and a linear mode in which an APD operates with a voltage difference between an anode voltage and a cathode voltage that is less than or equal to the breakdown voltage or near the breakdown voltage.

An APD that operates in the Geiger mode is referred to as a single-photon avalanche diode (SPAD). In the SPAD, for example, the voltage VL (first voltage) is -30 V and the voltage VH (second voltage) is 1 V.

A switch 202 is connected to the power supply line to which the drive voltage VH is supplied, and is also connected to one of the anode and the cathode of the APD 201. The switch 202 switches a resistance value between the APD 201 and the power supply line to which the drive voltage VH is supplied. The resistance value can be switched by changing the resistance value by tenfold or greater, or changing the resistance value by a hundredfold or more. Hereinafter, this resistance value becoming low is also referred to as the switch 202 being on, and this resistance value becoming high is also referred to as the switch 202 being off. In the configuration example illustrated in FIG. 4, the switch 202 is connected to the power supply line to which the drive voltage VH is supplied and also connected to the cathode of the APD 201. The switch 202 functions as a quench element. The switch 202 also functions as a load circuit (quench circuit) during signal multiplication caused by avalanche multiplication, and operates to reduce the voltage to be supplied to the APD 201 and suppress avalanche multiplication (quench operation). The switch 202 operates to cause a current corresponding to a voltage drop to flow in the quench operation, thereby returning the voltage to be supplied to the APD 201 to the drive voltage VH (recharge operation).

The switch 202 can be formed of a metal-oxide semiconductor (MOS) transistor. FIG. 4 illustrates an example where the switch 202 is a P-channel MOS (PMOS) transistor. A control signal CLK1 to be supplied to the switch 202 from a signal generation unit (not illustrated) is applied to a gate electrode of the MOS transistor constituting the switch 202. The voltage to be applied to the gate electrode of the switch 202 is controlled to thereby control the switch 202 to be turned on and off.

The signal processing circuit 103 includes a waveform shaping unit 210, a count circuit 211, a selection circuit 212, and a control unit 203.

The waveform shaping unit 210 receives, as a photon detection signal, a change in the voltage at the cathode of the APD 201 that is obtained upon detection of a photon, shapes the waveform of the input voltage, and outputs a pulse signal. In other words, the waveform shaping unit 210 outputs a signal based on the photon detection signal by avalanche multiplication as a pulse signal.

As the waveform shaping unit 210, for example, an inverter circuit is used. While FIG. 4 illustrates an example where one inverter is used as the waveform shaping unit 210, a circuit having a configuration in which a plurality of inverters is connected in series may be used, or any other circuit having a waveform shaping effect may also be used.

The count circuit 211 measures pulse signals output from the waveform shaping unit 210 and holds a count value. When a control pulse RES is supplied via a drive line 213, the signal held in the count circuit 211 is reset.

The control unit 203 controls the timing of measuring the pulse signals by the count circuit 211. The control unit 203 can be formed of an inverter and an AND circuit. One of input terminals of the control unit 203 is connected to the output terminal of the waveform shaping unit 210, and the other input terminal of the control unit 203 is connected to receive a control signal CLK2 to be supplied from the signal generation unit 215. The output terminal of the control unit 203 is connected to the count circuit 211.

In the photoelectric conversion device 100 according to the embodiment, the control unit 203 for controlling the timing of counting the number of output signals detects timing information indicating a timing when a photon is incident. Based on this timing information, it can be determined whether omissions in counting on a blinking light source have occurred. Specifically, the use of the photoelectric conversion device 100 according to the disclosure makes it possible to obtain information for determining whether omissions in counting due to the blinking light source have occurred.

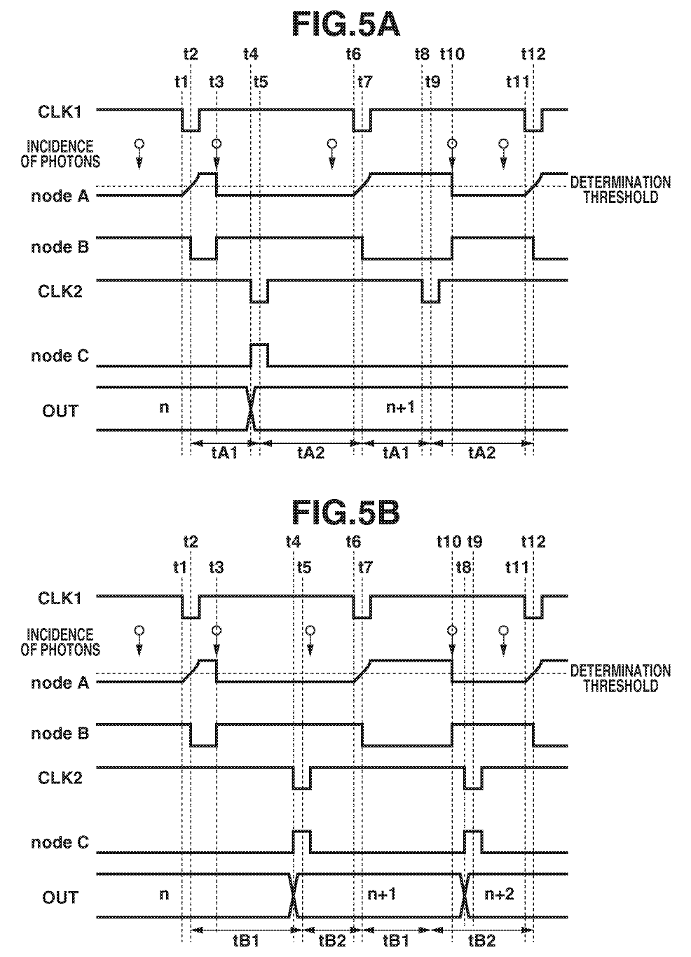

The selection circuit 212 is supplied with a control pulse SEL through a drive line 214 illustrated in FIG. 4 (not illustrated in FIG. 3) from the vertical scanning circuit 110 illustrated in FIG. 3, and switches an electrical connection and disconnection between the count circuit 211 and the signal line 113. The selection circuit 212 includes, for example, a buffer circuit for outputting signals and the like. An output signal OUT illustrated in FIGS. 5A and 5B is an output signal from each pixel 101.

FIGS. 5A and 5B schematically illustrate a relationship among the control signal CLK1, the control signal CLK2, a voltage at a node A, a voltage at a node B, a voltage at a node C, and the output signal OUT. FIG. 5A differs from FIG. 5B in regard to the timing when the control signal CLK2 is input. In FIGS. 5A and 5B, the timing when the control signal CLK2 is input corresponds to the timing when the control signal CLK2 changes from a high level to a low level. The control signal CLK1 is at least a plurality of control signals to be input during an exposure period corresponding to one frame. For example, 2048 control signals CLK1 are input during the exposure period corresponding to one frame. As described above, the control signal CLK1 is a signal for controlling the quench operation and the recharge operation of the APD 201. Accordingly, 2048 photon detection signals can be output by 2048 control signals CLK1. In other words, the exposure period corresponding to one frame in the photoelectric conversion unit 102 includes a plurality of detection periods during which signals based on the photon detection signal are output, and each detection period corresponds to a period between the adjacent control signals CLK1.

The exposure period corresponding to one frame according to the embodiment of the disclosure is the period from when counting is started by the count circuit 211 to when the count value is reset. Since the count value of the count circuit 211 is reset when the control pulse RES is supplied to the count circuit 211 via the drive line 213, the exposure period corresponding to one frame is determined based on the input timing of the control pulse RES serving as a reset signal. The count circuit 211 outputs the count value at the timing when the reset signal is input, and thus the output count value represents an image signal corresponding to one frame. Then, development processing and image processing are performed on the output count value, to thereby generate an image corresponding to one frame. Each frame indicates a still image. A "frame" refers to a unit representing a still image. While a single frame represents a still image, a plurality of frames is generated continuously in time and the generated frames are sequentially reproduced to thereby form a moving image. Accordingly, the exposure period corresponding to one frame indicates a time window for accumulating image signals in the process of generating a single still image. This time window is defined in various forms. For example, the time window is defined based on the timing of the reset signal input to the count circuit 211. In addition, the time window can be defined by controlling the period in which the photoelectric conversion device 100 is operating so as to detect photons by controlling the quench operation of the APD 201. Alternatively, the exposure period can be defined by controlling the period in which light passes in front of a sensor, such as a mechanical shutter, and is physically incident on the sensor. Thus, the exposure period corresponding to one frame is conceptually the period in which image signals for forming one frame (still image) are obtained. Specific examples of the exposure period include the period in which light is incident on a light-receiving surface of the photoelectric conversion device 100, the period in which the photoelectric conversion device 100 is operating so as to detect photons, and the period from start to end of counting by the count circuit 211. The exposure period can be read as a "detection period". According to the embodiment of the disclosure, the period from when counting is started by the count circuit 211 to when the count value is reset is defined as the exposure period corresponding to one frame as described above.

In this case, a signal to be output during the detection period is input to the control unit 203 as an output signal from the node B. The control signal CLK2 is also input to the control unit 203 to control the timing of counting output signals from the node B.

In the embodiment, the timing of the control signal CLK2 is changed so as to set the timing of the control signal CLK2 to be different from the timing of recharging the APD 201 (i.e., the timing when the control signal CLK1 is input). Timing information indicating the timing when a photon is incident can be obtained by changing the timing of inputting the control signal CLK2. Control of the timing of the control signal CLK2 and a specific measurement method for timing information will be described in detail below.

In the photoelectric conversion device according to the embodiment, when the control signal CLK1 is at the high level, the drive voltage VH is hardly supplied to the APD 201, and when the control signal CLK1 is at the low level, the drive voltage VH is supplied to the APD 201. The high level of the control signal CLK1 is, for example, 1 V, and the low level of the control signal CLK1 is, for example, 0 V. When the control signal CLK1 is at the high level, the recharge operation is hardly performed even when avalanche multiplication occurs in the APD 201. For this reason, the voltage to be supplied to the APD 201 after avalanche multiplication occurs in the APD 201 is less than or equal to the breakdown voltage of the APD 201. Accordingly, the avalanche multiplication operation in the APD 201 stops. An operation of the photoelectric conversion device 100 when the timing of the control signal CLK2 is fast and an operation of the photoelectric conversion device 100 when the timing of the control signal CLK2 is slow will be described below. The phrase "the timing of the control signal CLK2 is fast" indicates that a time interval between time when the control signal CLK1 is input and time when the control signal CLK2 is input is short. Similarly, the phrase "the timing of the control signal CLK2 is slow" indicates that a time interval between time when the control signal CLK1 is input and time when the control signal CLK2 is input is long.

### When Timing of CLK2 is Fast

At time t1 in FIG. 5A, the control signal CLK1 changes from the high level to the low level, and the recharge operation of the APD 201 is started. As a result, the voltage at the cathode of the APD 201 transitions to the high level. The voltage to be applied to the anode and the cathode of the APD 201 enables avalanche multiplication. The voltage at the cathode is equal to the voltage at the node A. Accordingly, when the voltage at the cathode transitions from the low level to the high level, the voltage at the node A at time t2 is more than or equal to a determination threshold. In this case, the pulse signal output from the node B is inverted and changed from the high level to the low level. After completion of the recharge operation, a voltage difference between the drive voltage VH and the drive voltage VL is applied to the APD 201. Thereafter, the control signal CLK1 changes to the high level.

Next, at time t3, a photon is incident on the APD 201, which causes avalanche multiplication in the APD 201, so that an avalanche multiplication current flows to the switch 202 and the voltage at the cathode drops. In other words, the voltage at the node A drops. If the voltage at the node A becomes lower than the determination threshold during the period in which the voltage at the node A drops, the voltage at the node B changes from the low level to the high level. At time t3, the signal input to one of the input terminals of the control unit 203 is at the high level and the control signal CLK2 input to the other input terminal is maintained at the high level. Accordingly, the voltage at the node C is maintained at the low level. Thus, the photon incident at time t3 is not output as a signal from the node C and the count value is also not incremented.

At time t4, the control signal CLK2 changes to the low level. Along with this change, the output from the node C changes to the high level and is output as a signal from the node C. Then, the signal is counted by the count circuit 211 and the count value is incremented by 1 LSB.

A photon is incident on the APD 201 between time t4 and time t6. However, the voltage to be applied to the APD 201 has not reached the voltage difference that enables avalanche multiplication. Thus, the voltage level at the node A does not exceed the determination threshold.

At time t6, the control signal CLK1 changes from the high level to the low level, so that the switch 202 is turned on. Along with this change, the voltage at the node A transitions to the original voltage level. At time t7, the voltage at the node A becomes more than or equal to the determination threshold, so that the pulse signal from the node B is inverted and changes from the high level to the low level. Next, at time t8, the control signal CLK2 changes to the low level. However, since no photon is incident on the APD 201 during the period from time t7 to time t8, the voltage at the node B has not changed to the high level at time t8. Accordingly, the count value is maintained.

Thereafter, a photon is incident at time t10. However, since the control signal CLK2 has already changed from the low level to the high level at time t8, the photon incident at time t10 is not output as a signal from the node C, and the count value is not incremented.

That is, the control signal CLK1 changes to the high level, the control signal CLK2 changes to the low level after time t2 and time t7 when the voltage at the node A exceeds the determination threshold, and the photon incident during time tA1 before time t5 and time t9 when the inversion of the voltage at the node A due to the incidence of the photon can be detected is counted. On the other hand, after time t5 and time t9, the control signal CLK1 changes to the high level and the photon incident during time tA2 before time t7 and time t12 when the voltage at the node A exceeds the determination threshold is not counted. Each of time t5 and time t9 is an intermediate time in the period in which the control signal CLK2 is at the low level. This is because time tA1 when the inversion of the voltage at the node A can be detected based on the time that is a little behind the time of a falling edge of the control signal CLK2 is set in consideration of a delay and the like in circuit elements and wiring. Accordingly, it can be said that time tA1 is the time for ensuring the detection of the inversion of the voltage at the node A due to the incidence of a photon. Each of time t5 and time t9 may be time before a falling edge of the control signal CLK2 from the intermediate time in the period in which the control signal CLK2 is at the low level.

Since the control signal CLK1 is a signal for controlling the recharge operation of the APD 201, the period from time t1 to time t6 and the period from time t6 to time t11, each of which indicates a cycle of the control signal CLK1, are referred to as a recharge cycle. The recharge cycle also corresponds to the detection period described above and is a cycle for outputting one photon detection signal.

### When Timing of CLK2 is Slow

FIG. 5B illustrates a state where the timing of the control signal CLK2 in the recharge cycle is slower than that in FIG. 5A. In other words, the time interval from time when the control signal CLK1 is input to when the control signal CLK2 is input is longer than that in FIG. 5A. In FIG. 5B, a photon incident during time tB1 is counted as a signal value and a photon incident during time tB2 is not counted.

As seen from the comparison between FIGS. 5A and 5B, time tB1 is longer than time tA1. Accordingly, the photon that is not counted in FIG. 5A is counted in FIG. 5B. Specifically, in FIG. 5B, not only the photon incident at time t3, but also the photon incident on time t10 is counted.

As described above, it is obvious that the measurement result of each signal based on the photon detection signal can be changed by changing the timing when the control signal CLK2 is input. Based on time t4 when the control signal CLK2 is input, the recharge cycle (detection period) can be divided into a first period before the control signal CLK2 is input and a second period after the control signal CLK2 is input. In other words, the detection period includes the first period and the second period that is subsequent to the first period and does not overlap the first period.

The photon detection signal output from the node A in the first period is counted when the control signal CLK2 is input (time t4, t8). However, the photon detection signal output from the node B in the second period is not counted.

Accordingly, in the recharge cycle (detection period), information indicating whether the photon detection signal has been output (counted) in the first period can be obtained as timing information indicating the timing when a photon is incident. Further, the length of the first period can be adjusted by changing the cycle of the control signal CLK2 as illustrated in FIGS. 5A and 5B, so that desired timing information can be obtained.

In a case where non-uniformity of photons incident during the exposure period is determined based on such timing information, the detection periods in which the photon detection signal is counted in the first period may be observed. For example, if the control signal CLK1 is input 2048 times during one exposure period, the detection period in which the photon detection signal is output in the first period and the detection period in which no photon detection signal is output in the first period are measured. In general, in the case of capturing bright constant light, the number and density of photons incident during the exposure period increase, and thus it is highly likely that photons are incident in the first half of the detection period. On the other hand, in the case of capturing dark constant light, it is less likely that photons are incident in the first half of the detection period, and it is highly likely that photons are not incident in the latter half of the detection period or during the detection period.

Accordingly, in the case of capturing constant light, the brightness of light is constant, and thus the number of detection periods in which the photon detection signal is output in the first period is approximately equal to "2048" or "0". Even when the brightness of constant light has intermediate luminance, the number of detection periods in which the photon detection signal is output in the first period can be polarized by measuring the length of the first period (i.e., the cycle of the control signal CLK2), for example, by delaying the detection period as illustrated in FIG. 5B.

In the case of a light source that periodically blinks, like a light emitting diode (LED) light source, the number of detection periods in which the photon detection signal has been output in the first period is substantially equal to the number of detection periods in which the photon detection signal has not been output in the first period. The number of detection periods in which the photon detection signal is output in the first period corresponds to the count value of the count circuit 211. Accordingly, the count value in the exposure period corresponding to one frame may be referenced.

Then, non-uniformity of photons incident during the exposure period can be determined by comparing the number of detection periods (i.e., the number of control signals CLK1) in the exposure period corresponding to one frame with the count value. The number of detection periods in the exposure period corresponding to one frame corresponds to a maximum value of the count value. Accordingly, the number of detection periods in which the photon detection signal has not been output in the first period can be obtained by subtracting the obtained count value. However, non-uniformity may be determined without using the number of detection periods.

Thus, in the case of determining non-uniformity of photons, the number of first signals that are signals based on the photon detection signal output in the first period is compared with a predetermined threshold (e.g., the value that is 80% to 90% of the detection period in the exposure period corresponding to one frame). If the number of first signals is more than or equal to the predetermined threshold, it is determined that photons are uniformly incident on the photoelectric conversion unit 102. On the other hand, if the number of first signals is less than the predetermined threshold, it is determined that photons are not uniformly incident on the photoelectric conversion unit 102.

As described above, in the photoelectric conversion device according to the embodiment, the exposure period corresponding to one frame includes a plurality of detection periods in which signals based on the photon detection signal are output. Further, the signals based on the photon detection signal output during a predetermined period (first period) in the detection period are counted, and non-uniformity of photons incident on the photoelectric conversion unit 102 is determined based on the count value.

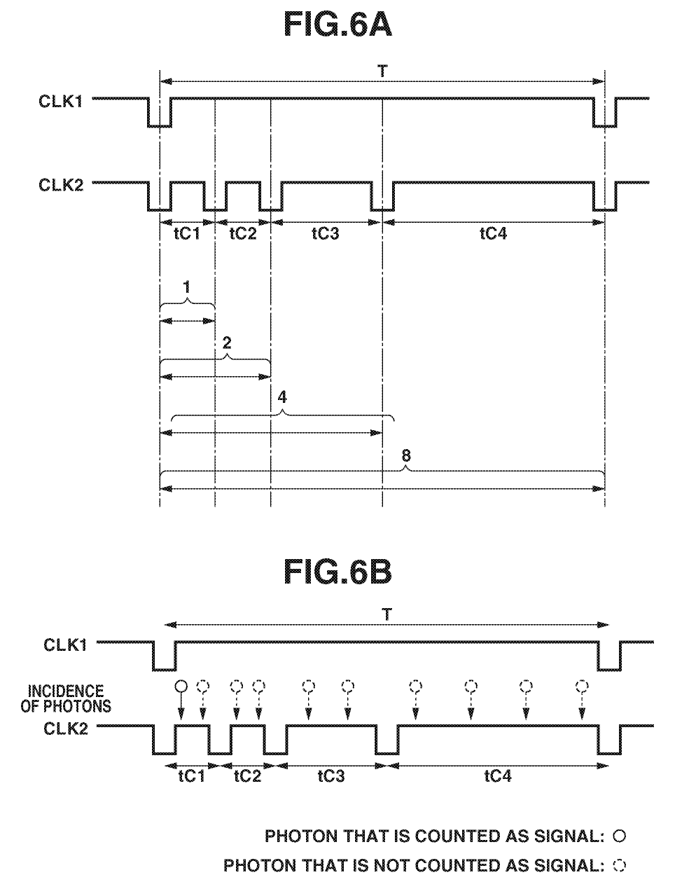

While FIGS. 5A and 5B illustrate a case where the pulse signal of the control signal CLK2 is input only once in every recharge cycle, a plurality of pulse signals may be input. FIG. 6A illustrates an example where the pulse signal of the control signal CLK2 is input four times in every recharge cycle. In this example, photons can be detected in four time windows tC1, tC2, tC3, and tC4 with different durations in every recharge cycle T.

The time window tC1 is a period in which the control signal CLK2 changes to the high level for the first time after the recharge operation, and the time window tC2 is a period in which the control signal CLK2 changes to the high level for the second time after the control signal CLK2 changes to the high level for the first time. Similarly, the time window tC3 is a period in which the control signal CLK2 changes to the high level for the third time after the control signal CLK2 changes to the high level for the second time, and the time window tC4 is a period in which the control signal CLK2 changes to the high level for the fourth time after the control signal CLK2 changes to the high level for the third time. The time when the control signal CLK2 changes to the high level for the fourth time corresponds to the timing when the pulse signal of the control signal CLK1 is input.

To improve the efficiency of detecting incident photons within the recharge cycle T, the time windows tC1 + tC2 + tC3 + tC4 can be set to match the recharge cycle T. In other words, the timing for measuring the output signal can be controlled so that one of the timings of measuring the output signal matches the timing of recharging the avalanche photodiode.

The widths of the four time windows tC1, tC2, tC3, and tC4 can be exponentially increased from the fastest time window to the latest time window in the recharge cycle such that, for example, tC1 : tC1 + tC2 : tC1 + tC2 + tC3 : tC1 + tC2 + tC3 + tC4 (recharge cycle) = 1 : 2 : 4 : 8 holds. Since the intensity of light is inversely proportional to an average photon arrival interval, the width of each time window can be exponentially changed from the narrowest time window to the widest time window so as to efficiently detect non-uniformity of timings when photons are incident.

As seen from FIGS. 5A and 5B, once a photon is incident within a recharge cycle T and avalanche multiplication occurs, avalanche multiplication does not occur (quench operation) even when another photon is input until the recharge operation is performed again. Accordingly, like in the example illustrated in FIG. 6B, only one photon that is incident in the earliest time window is output as an output signal among the photons incident within the recharge cycle T. Thus, the signals based on the photon detection signal can be individually counted in the first period and the second period that is subsequent to the first period and does not overlap the first period in the four time windows included in the detection period. More specifically, the signals based on the photon detection signal are exclusively counted in one of the first period included in one detection period and the second period that does not overlap the first period.

In the following embodiments, an example where the control signal CLK2 is input four times in every recharge cycle T as illustrated in FIGS. 6A and 6B will be described. However, the control signal CLK2 may be input only once as illustrated in FIGS. 5A and 5B, or may be input any number of times. The control signal CLK2 can be input a plurality of times in every detection period (recharge cycle T). This is because the resolution of timing information obtained for determination of non-uniformity of incident photons is dependent on the number of control signals CLK2 in every recharge cycle T. A finer measurement of photon incidence timings and observation of a distribution of photon incidence timings make it possible to more easily determine a temporal brightness change, that is, non-uniformity of photon incidence timings.

### First Embodiment

A photoelectric conversion device according to a first embodiment has a configuration in which the count circuit 211 obtains the count value corresponding to one frame in each of the four time windows tC1, tC2, tC3, and tC4 controlled by the control signal CLK2. The count values of the four time windows tC1, tC2, tC3, and tC4 are compared to thereby obtain timing information indicating the timing when a photon is incident within the recharge cycle T.

In other words, the first signals based on the photon detection signal are counted in the first period (any one of four time windows), and the second signals based on the photon detection signal are counted in the second period (period that is subsequent to the first period and does not overlap the first period). Further, non-uniformity of photons incident on the photoelectric conversion device is determined based on a distribution of count values of the first signals and the second signals.

The first period may be any one of the four time windows, and the second period may be a time window that is subsequent to the first period and does not overlap the first period. The count values to be compared are not limited to the count values of the two periods, that is, the first period and the second period. Alternatively, count values in three or more periods (time windows) may be compared.

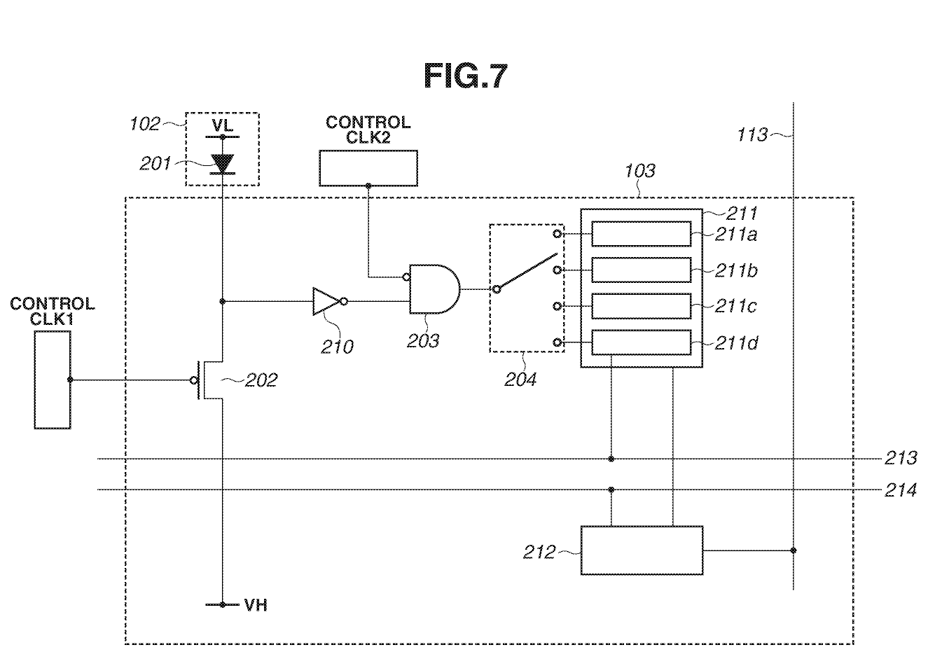

FIG. 7 is an equivalent circuit diagram illustrating the photoelectric conversion device according to the first embodiment. The count circuit 211 in the photoelectric conversion device according to the first embodiment includes four count circuits 211a, 211b, 211c, and 211d, and is configured to count the number of output signals from the four time windows tC1, tC2, tC3, and tC4. In other words, the count circuit 211 includes a first count circuit configured to count the number of output signals at each of a plurality of timings. While FIG. 7 illustrates a case where the photoelectric conversion device includes a switch 204 configured to switch the count circuit to be connected to the output terminal of the control unit 203, the photoelectric conversion device may include a plurality of control units 203 corresponding to the count circuits 211a, 211b, 211c, and 211d, respectively. As illustrated in FIG. 6B, only one photon can be detected in every control signal CLK1 and this detection period includes four time windows. Accordingly, photons are exclusively detected in each period.

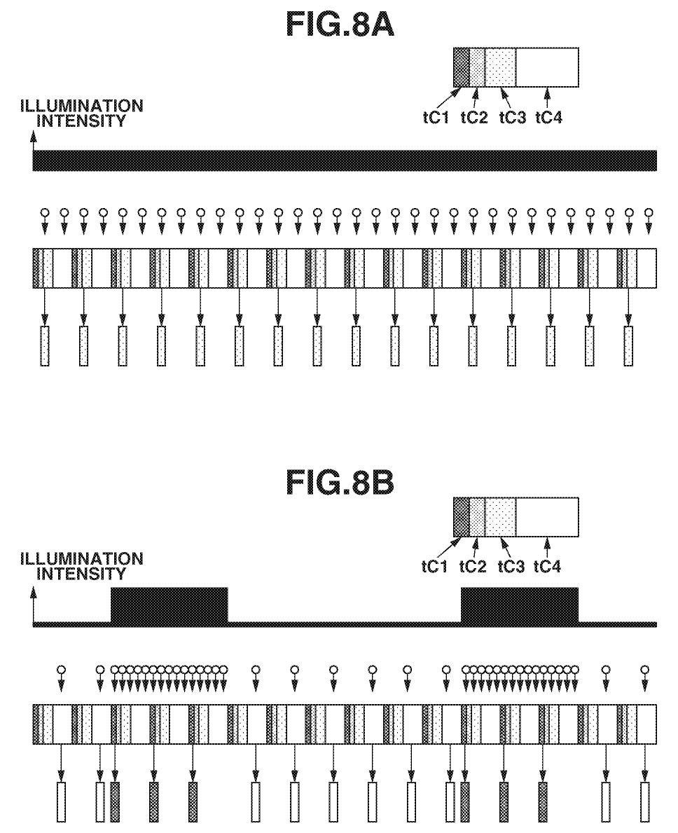

FIG. 8A illustrates a state where photons are counted when constant light is used as illumination light. If constant light is used as illumination light and shot noise (fluctuations of photons) is ignored, photons are incident at a predetermined frequency. In general, the probability of incidence of a photon is correlated to the brightness. As the brightness of an object increases, a photon is incident at an earlier timing in one detection period. For example, in the first embodiment, as the brightness of an object increases, the probability that a photon is incident in the time window tC1 for the first time increases. Further, if constant light is used as illumination light, photons are more likely to be incident at a constant timing in every detection period (every control signal CLK1). FIG. 8A illustrates a state where photons incident in the time window tC3 of the same type are counted in each recharge cycle T. FIG. 8A illustrates 16 detection periods corresponding to one frame. The count value of each of the count circuits 211a, 211b, and 211d in the four time windows corresponding to one frame is 0 LSB, and the count value of the count circuit 211c in the four time windows corresponding to one frame is 16 LSB.

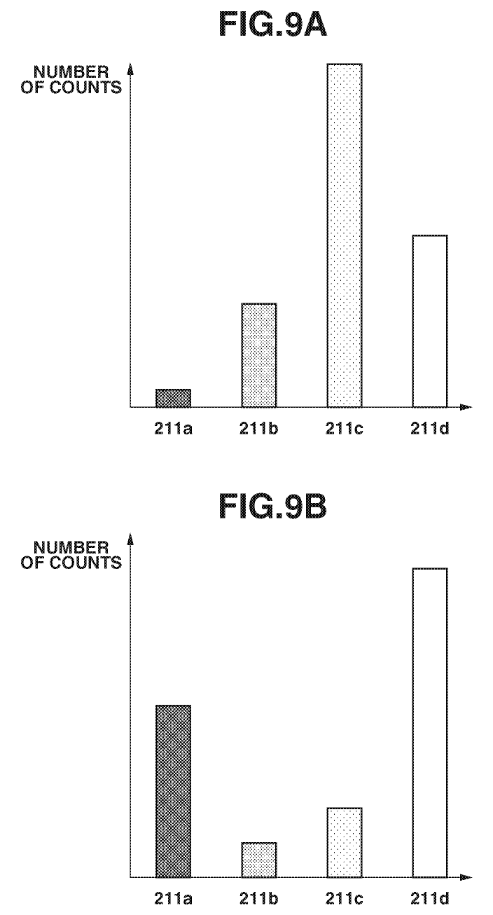

Since there is shot noise (fluctuations of photons) in practice, signals based on the photon detection signal are not constantly counted at the same timing. Thus, the count values of the count circuits 211a, 211b, and 211d are not exactly equal to 0 LSB, and the count value of the count circuit 211c is a value smaller than 16 LSB. However, the count value of the count circuit 211c still tends to be greater than the count values of the count circuits 211a, 211b, and 211d. Accordingly, if a sufficiently large number of detection periods (control signals CLK1) corresponding to one frame can be set (e.g., 2048 detection periods), a histogram of count values of the time windows can be obtained as illustrated in FIG. 9A. Specifically, a unimodal histogram with the count value of the count circuit 211c as a local maximum point can be obtained. Thus, non-uniformity in the histogram in which the count value of one time window increases is determined to thereby determine whether the light is steady light with little temporal change in the amount of light to be incident on the photoelectric conversion device.

On the other hand, FIG. 8B illustrates a state where photons are counted when a blinking light source is used as illumination light. If a blinking light source is used as illumination light, the frequency of incidence of photons at a timing when the blinking light source is turned on is high, and the frequency of incidence of photons at a timing when the blinking light source is turned off is low. In other words, photons are more likely to be detected at an earlier timing during one detection period when the light source is turned on, and photons are more likely to be detected at a later timing during one detection period when the light source is turned off. In the example illustrated in FIG. 8B, the detection period in which the probability of detecting a photon in the time window tC1 is high and the period in which the probability of detecting a photon in the time window tC4 is high are present. If photon shot noise is ignored, signals based on the photon detection signal are counted in different types of time windows at the timing when the light source is turned on and at the timing when the light source is turned off. FIG. 8B illustrates an example where the count value of each of the count circuits 211b and 211c in the four time windows corresponding to one frame is 0 LSB, the count value of the count circuit 211a in the four time windows corresponding to one frame is 6 LSB, and the count value of the count circuit 211d in the four time windows corresponding to one frame is 10 LSB.

Similarly, since there is shot noise (fluctuations of photons) in practice, the count value of each of the count circuits 211b and 211c is not exactly equal to 0 LSB, and the count values of the count circuits 211a and 211d are smaller than 6 LSB and 10 LSB, respectively. However, if a sufficiently large number of detection periods corresponding to one frame can be set and a histogram of count values of the time windows can be obtained, a histogram as illustrated in FIG. 9B can be obtained. Specifically, a bimodal histogram with the count values of the count circuits 211a and 211d as local maximum points can be obtained. Thus, the determination of non-uniformity in the histogram in which the count values of two time windows increase makes it possible to determine whether the light is non-constant light with a large temporal change in the amount of light to be incident on the photoelectric conversion device, or whether the light is blinking light.

As seen from the comparison between FIGS. 9A and 9B, non-uniformity of count values of four time windows corresponding to one frame when constant light is used as illumination light is greatly different from that when a blinking light source is used as illumination light.

Accordingly, the photoelectric conversion device according to the first embodiment counts signals based on the photon detection signal in the first period and the second period, which is subsequent to the first period and does not overlap the first period, among the plurality of detection periods in at least one exposure period. Then, signals based on the photon detection signal in the first period are counted as the first signal, and signals based on the photon detection signal in the second period are counted as the second signal. Lastly, a distribution of the count values of the first signal and the second signal is calculated in the form of, for example, a histogram, and non-uniformity of photons is determined based on the calculated distribution.

As a more detailed determination method, non-uniformity of photons can be determined based on the comparison between the count value of the first signal and the count value of the second signal. For example, it is determined whether the difference between the count value of the first signal and the count value of the second signal is more than or equal to a predetermined threshold. If the difference is more than or equal to the predetermined threshold, it can be determined that photons are uniformly incident on the photoelectric conversion unit 102.

As described above, the configuration of the photoelectric conversion device according to the first embodiment makes it possible to obtain timing information indicating the timing when a photon is incident and to determine non-uniformity of incident photons.

A non-uniformity information generation unit that creates a histogram as illustrated in FIGS. 9A and 9B based on the count values of four time windows and obtains information about non-uniformity of timings when photons are incident may be provided in the photoelectric conversion device, or may be provided outside of the photoelectric conversion device.

A histogram as illustrated in FIGS. 9A and 9B is generated based on the count values of four time windows corresponding to one frame, thereby obtaining information about non-uniformity of timings when photons are incident. On the other hand, if the count values of four time windows corresponding to one recharge cycle T (corresponding to one control signal CLK1) can be obtained, non-uniformity information can be generated. However, a histogram can be generated based on count values corresponding to a plurality of recharge cycles T (e.g., 2048 control signals CLK1 as described above), which leads to an improvement in the accuracy of non-uniformity information.

Furthermore, the count value of the first signal and the count value of the second signal can be obtained in a plurality of exposure periods, and non-uniformity of incident photons can be determined based on the obtained count values. Consequently, the tendency in the way the count values are biased is more likely to appear than when non-uniformity of photons incident during one exposure period is determined, so that non-uniformity of incident photons can be determined more accurately. The determination method is similar to that used when one exposure period is set, and thus the description thereof is omitted.

### Second Embodiment

A photoelectric conversion device according to a second embodiment differs from the photoelectric conversion device according to the first embodiment in regard to the configuration of the count circuit 211. Specifically, the count circuit 211 according to the second embodiment is configured to obtain the count values in four time windows at once and to individually count the count values in some time windows. Thus, obtaining the count values of a plurality of time windows at once makes it possible to reduce the circuit size of the count circuit 211.

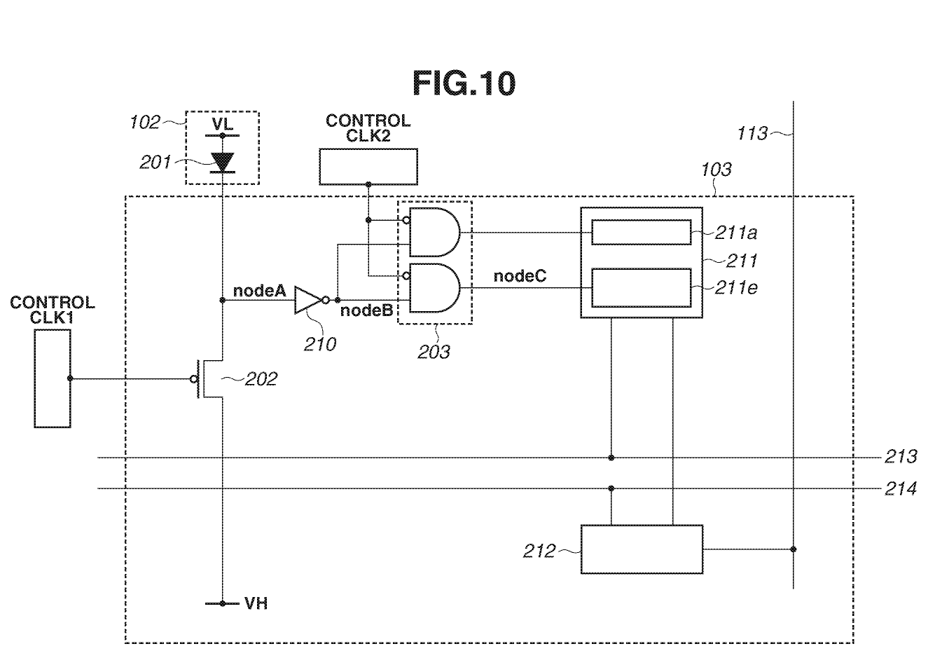

FIG. 10 is an equivalent circuit diagram illustrating the photoelectric conversion device according to the second embodiment. The count circuit 211 in the photoelectric conversion device according to the second embodiment includes a first count circuit 211a and a second count circuit 211e. The first count circuit 211a is configured to count the number of outputs from the time window tC1, and the second count circuit 211e is configured to obtain the total count value of the four time windows tC1, tC2, tC3, and tC4.

FIG. 10 illustrates a case where the photoelectric conversion device includes a plurality of control units 203 corresponding to the first count circuit 211a and the second count circuit 211e, respectively. Alternatively, each circuit may be configured using a switch as illustrated in FIG. 7.

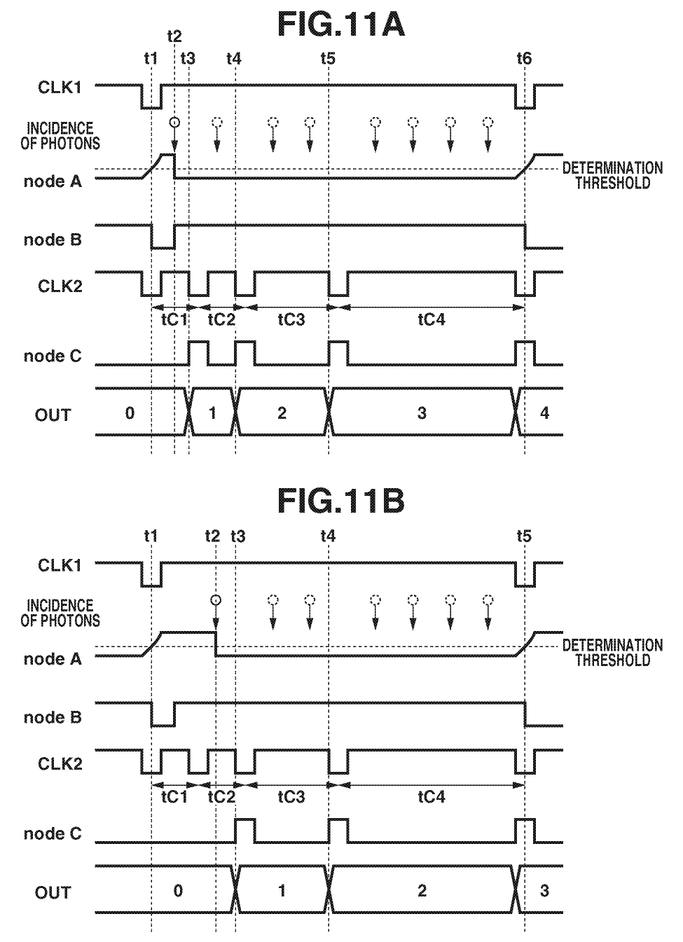

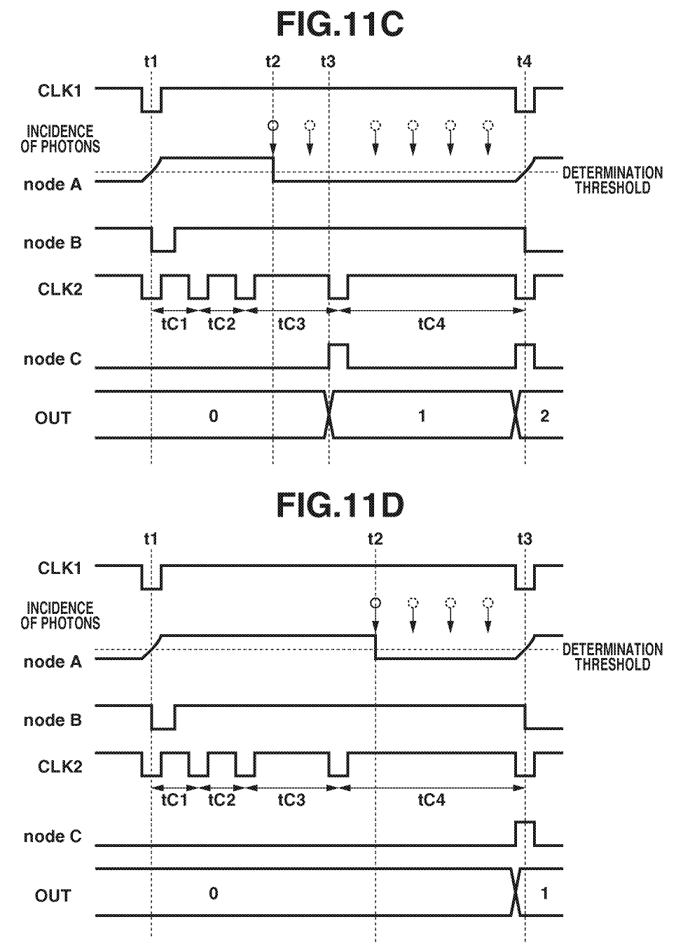

FIGS. 11A-11D each illustrate a method for counting the total number of count values of the four time windows in the second count circuit 211e. FIG. 11A illustrates a case where a photon is incident in the time window tC1, and FIG. 11B illustrates a case where no photon is incident in the time window tC1 and a photon is incident in the time window tC2. Similarly, FIG. 11C illustrates a case where no photon is incident in the time windows tC1 and tC2 and a photon is incident in the time window tC3, and FIG. 11D illustrates a case where no photon is incident in the time windows tC1 to tC3 and a photon is incident in the time window tC4.

As illustrated in FIG. 11A, at time t1, the voltage at the node A becomes more than or equal to the determination threshold, so that the voltage at the node B changes to the low level. Thereafter, the recharge operation of the APD 201 is completed. At time t2 when a photon is incident in the time window tC1 for the first time, avalanche multiplication occurs in the APD 201 and the voltage at the node B changes to the high level. At time t3 when a pulse signal is input to the control signal CLK2, the control signal CLK2 changes to the low level, so that the count value of the second count circuit 211e is incremented by 1 LSB.

Thereafter, the voltage at the node B is maintained at the high level, and thus the count value of the second count circuit 211e is incremented by 1 LSB at time t4, time t5, and time t6 when a pulse signal is input to the control signal CLK2.

Specifically, the photon incident in the time window tC1 is counted as 4 LSB in the second count circuit 211e.

Similarly, as seen from FIGS. 11B, 11C, and 11D, the photons that are incident for the first time in the time window tC2, the time window tC3, and the time window tC4 within the recharge cycle T, the photons are counted as 3 LSB, 2 LSB, and 1 LSB, respectively. In other words, the photons incident in the plurality of time windows tC1, tC2, tC3, and tC4, respectively, are counted with different weights from each other. Accordingly, even if the same count circuit is used, the time windows in which the respective photons are incident can be distinguished from each other.

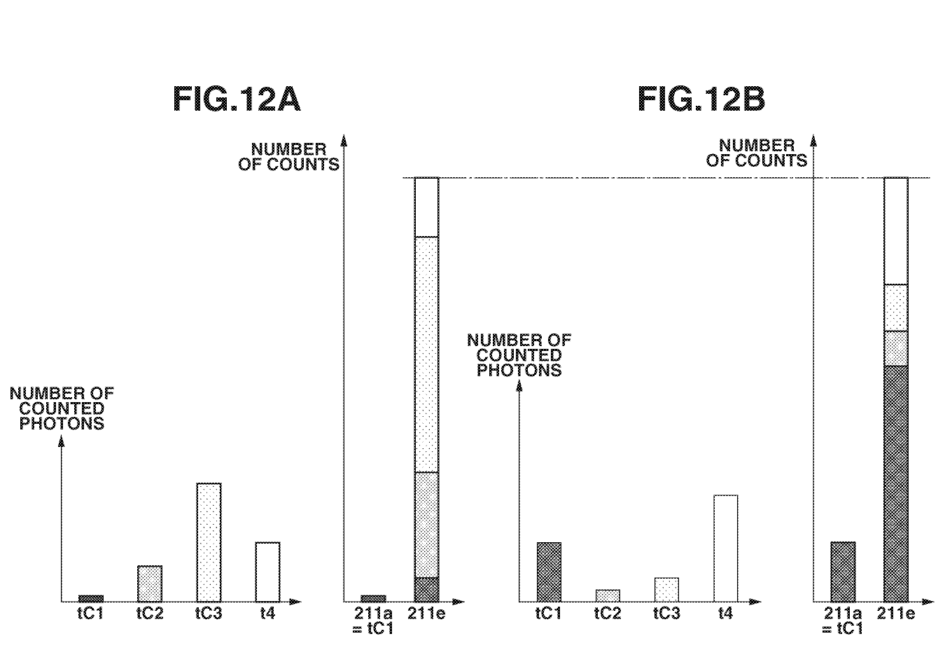

FIG. 12A illustrates a state where photons are counted in the first count circuit 211a and the second count circuit 211e when constant light is used as illumination light. On the other hand, FIG. 12B illustrates a state where photons are counted in the first count circuit 211a and the second count circuit 211e when a blinking light source is used as illumination light. In histograms illustrated in FIGS. 12A and 12B, tC1 to tC4 represent the number of photons counted in the respective time windows, and 211a and 211e represent count values of the count circuits 211a and 211e, respectively.

As seen from the comparison between FIGS. 12A and 12B, the relationship between the count value of the first count circuit 211a and the count value of the second count circuit 211e when constant light is used as illumination light is greatly different from that when a blinking light source is used as illumination light. Specifically, although the count value of the count circuit 211e illustrated in FIG. 12A is equal to the count value of the count circuit 211e illustrated in FIG. 12B, the count value of the count circuit 211a illustrated in FIG. 12A is smaller than the count value of the count circuit 211a illustrated in FIG. 12B. In other words, non-uniformity of timings when photons are incident within the recharge cycle T can be obtained by comparing the count value of the first count circuit 211a with the count value of the second count circuit 211e.

The above-described configuration of the photoelectric conversion device according to the second embodiment makes it possible to obtain timing information indicating the timing when a photon is incident and to determine whether omissions in counting on a blinking light source have occurred. In other words, the photoelectric conversion device according to the second embodiment can obtain information for determining whether omissions in counting on the blinking light source have occurred.

While FIG. 10 illustrates a case where the first count circuit 211a obtains the count value of the time window tC1, photons incident in time windows other than the time window tC1 may be counted by the first count circuit 211a. For example, photons incident in a plurality of time windows, such as the time windows tC1 and tC2, may be counted.

As seen from FIGS. 9A and 9B and 12A and 12B, the count value of an earlier time window can be obtained separately from the count value of a later time window so as to accurately estimate non-uniformity due to the blinking light source. In other words, a count circuit configured to count the number of output signals at a timing earlier than a specific threshold within the recharge cycle T can be used as the first count circuit 211a.

Photons can be individually counted in a plurality of time windows, such as the time windows tC1 and tC2, as the count value, which makes it possible to accurately estimate non-uniformity due to the blinking light source. On the other hand, as illustrated in FIG. 10, photons can be individually counted in a single time window as the count value, which makes it possible to reduce the circuit size of the count circuit. In other words, a count circuit configured to count the number of output signals at an earliest timing within the recharge cycle T can be used as the first count circuit 211a.

### Third Embodiment

In the photoelectric conversion device according to the second embodiment, each pixel 101 includes both the first count circuit 211a for obtaining information about non-uniformity due to the blinking light source and the second count circuit 211e for obtaining the total count value. On the other hand, in a photoelectric conversion device according to a third embodiment, the second count circuit 211e for obtaining the total count value is provided in each pixel 101, while the first count circuit 211a for obtaining information about non-uniformity due to the blinking light source is provided in every predetermined number of pixels 101. Thus, the first count circuit 211a for obtaining information about non-uniformity is shared by the plurality of pixels 101, which leads to a further reduction in the circuit size of the count circuit.

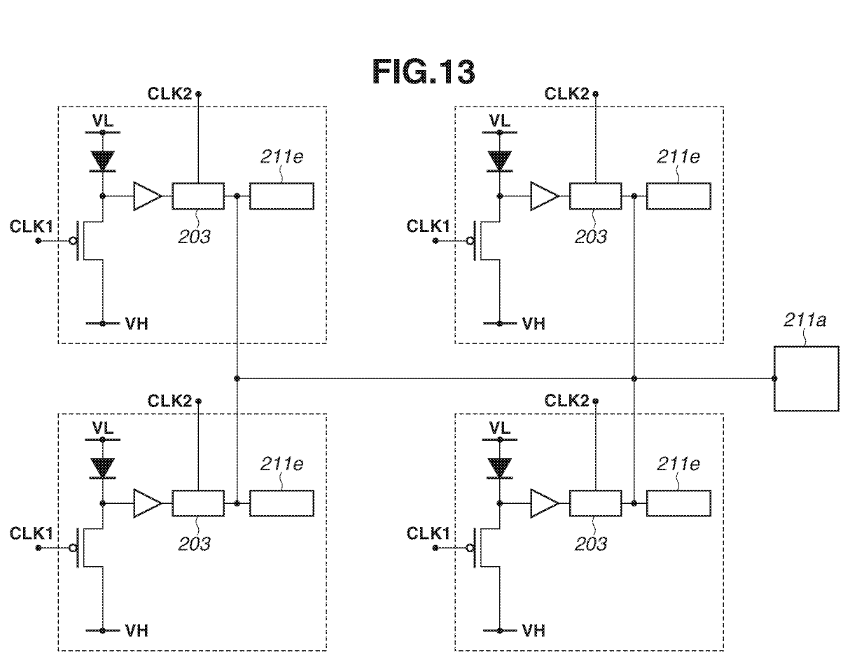

FIG. 13 is an equivalent circuit diagram illustrating the photoelectric conversion device according to the third embodiment. In FIG. 13, some circuits are illustrated in a simplified manner for ease of illustration. However, the details of the omitted portions are similar to those illustrated in FIG. 10. As illustrated in FIG. 13, the photoelectric conversion device according to the third embodiment includes the second count circuit 211e for obtaining the total count value in each pixel 101. The photoelectric conversion device according to the third embodiment also includes the first count circuit 211a for obtaining the count value of the time window tC1 in every four pixels 101 in two rows and two columns. While FIG. 13 illustrates an example where the first count circuit 211a is shared by four pixels 101 in two rows and two columns, the number of pixels 101 is not limited to four.

The first count circuit 211a may count photons incident in the time window tC1 on one of the four pixels 101 in two rows and two columns. Further, an OR circuit may be used to count photons incident in the time window tC1 on any one of the four pixels 101, or an AND circuit may be used to count photons incident in the time window tC1 on all the four pixels 101. Like in the second embodiment, photons incident in time windows other than the time window tC1 may be counted by the first count circuit 211a. For example, photons incident in a plurality of time windows, such as the time windows tC1 and tC2, may also be counted.

### Fourth Embodiment

Unlike the photoelectric conversion devices according to the first to third embodiments, a photoelectric conversion device according to a fourth embodiment does not include the first count circuit 211a for obtaining the number of counts of photons incident in a specific time window, and includes only the second count circuit 211e for obtaining the total count value. Alternatively, the number of output signals counted by the second count circuit 211e in one recharge cycle T is compared with the number of output signals counted by the second count circuit 211e in another recharge cycle T, thereby making it possible to obtain timing information indicating the timing when a photon is incident.

This configuration eliminates the need for the count circuit for obtaining the number of counts of photons incident in a specific time window, which leads to a further reduction in the circuit size of the count circuit. On the other hand, the configuration according to the fourth embodiment is to compare the number of output signals counted by the second count circuit 211e in every recharge cycle T, which leads to an increase in the amount of data to be output from the output circuit 114. Thus, the configurations according to the first to third embodiments are more advantageous in terms of the amount of data.

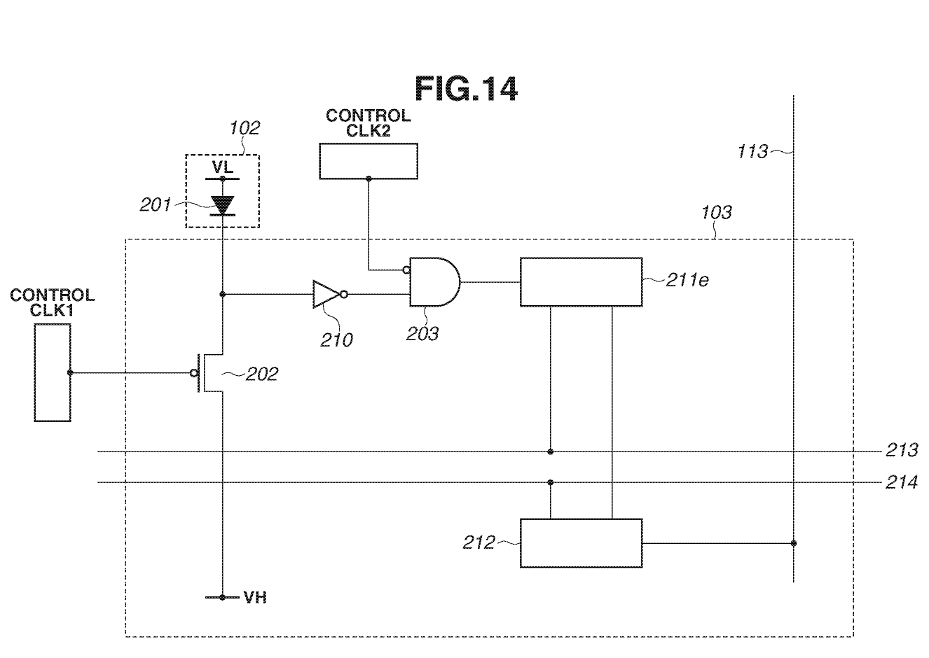

FIG. 14 is an equivalent circuit diagram illustrating the photoelectric conversion device according to the fourth embodiment. As illustrated in FIG. 14, the photoelectric conversion device according to the fourth embodiment includes only the second count circuit 211e for obtaining the total count value.

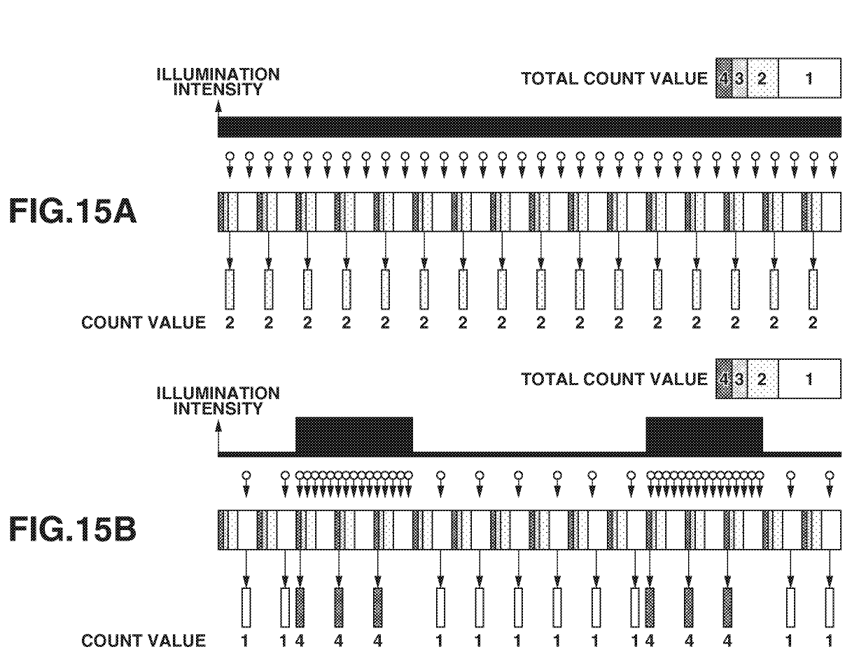

FIG. 15A illustrates a state where photons are counted when constant light is used as illumination light. If constant light is used as illumination light and shot noise (fluctuations of photons) is ignored, photons are incident at a predetermined frequency. Accordingly, in each recharge cycle T, photons incident in the time window of the same type (tC3 in FIG. 15A) are counted. Thus, in the example illustrated in FIG. 15A, a count value 2 LSB is output from the second count circuit 211e in all recharge cycles T.

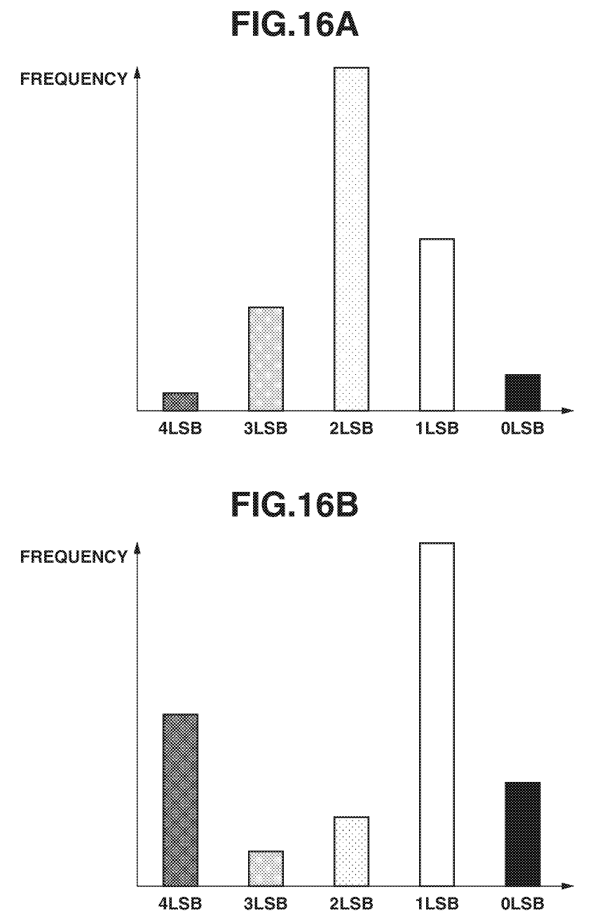

Since there is shot noise (fluctuations of photons) in practice, not all the count values in every recharge cycle T are 2 LSB. Specifically, a unimodal histogram with 2 LSB as a local maximum point can be obtained as illustrated in FIG. 16A.

FIG. 15B illustrates a state where photons are counted when a blinking light source is used as illumination light. In the case of using a blinking illumination light as illumination light, the frequency of incidence of photons at the timing when the blinking light source is turned on is high, and the frequency of incidence of photons at the timing when the blinking light source is turned off is low. Similarly, if photon shot noise is ignored, photons incident in the time window of the same type (tC1 in FIG. 15B) at the timing when the light source is turned on are counted, and photons incident in the time window of the same type (tC4 in FIG. 15B) at the timing while the light source is turned off are counted. Accordingly, in some of the recharge cycles T, a count value 1 LSB is output from the second count circuit 211e, and in the other recharge cycles T, a count value 4 LSB is output from the second count circuit 211e.

Similarly, since there is shot noise (fluctuations of photons) in practice, count values, such as 0 LSB, 2 LSB, and 3 LSB, can also be output. Specifically, as illustrated in FIG. 16B, a bimodal histogram with 1 LSB and 4 LSB as local maximum points can be obtained.

As seen from the comparison between FIGS. 16A and 16B, non-uniformity of count values of four time windows corresponding to one frame when constant light is used as illumination light is greatly different from that when the blinking light source is used as illumination light.

As described above, the configuration of the photoelectric conversion device according to the fourth embodiment makes it possible to obtain timing information indicating the timing when a photon is incident and to determine whether omissions in counting on the blinking light source have occurred based on the timing information. In other words, the photoelectric conversion device according to the fourth embodiment can obtain information for determining whether omissions in counting on the blinking light source have occurred.

A non-uniformity information generation unit that creates a histogram as illustrated in FIGS. 16A and 16B and obtains information about non-uniformity of timings when photons are incident may be provided in the photoelectric conversion device, or may be provided outside of the photoelectric conversion device.

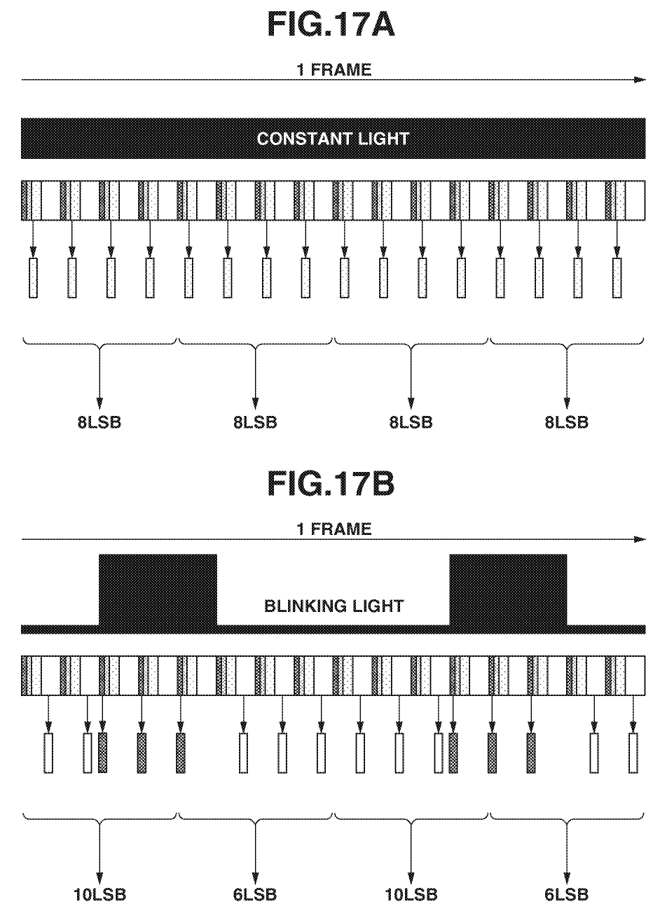

While FIGS. 15A and 15B illustrate a case where the number of counts is compared for every recharge cycle T, the number of counts may be compared for every predetermined number of recharge cycles T. For example, FIGS. 17A and 17B are timing diagrams when the number of counts is compared every four recharge cycles T. FIG. 17A illustrates a case where constant light is used as illumination light, and FIG. 17B illustrates a case where a blinking light source is used as illumination light. As seen from the comparison between FIGS. 15A and 15B and FIGS. 17A and 17B, the number of recharge cycles T to be compared can be reduced as illustrated in FIGS. 15A and 15B, which makes it possible to accurately obtain information about non-uniformity of timings when photons are incident. On the other hand, the number of recharge cycles T to be compared can be increased, which makes it possible to reduce the amount of data to be output.

### Fifth Embodiment

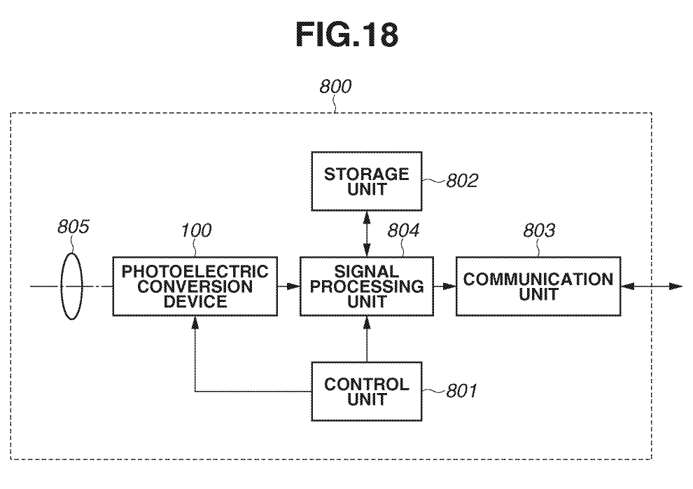

FIG. 18 is a block diagram illustrating a photoelectric conversion system incorporating any one of the photoelectric conversion devices according to the first to fourth embodiments. A photoelectric conversion system 800 includes the photoelectric conversion device 100, a control unit 801, a storage unit 802, a communication unit 803, a signal processing unit 804, and an imaging optical system 805.

The photoelectric conversion device 100 captures an optical image formed by the imaging optical system 805. The signal processing unit 804 corrects omissions in counting by using signals read out from the photoelectric conversion device 100 and information that is output from the photoelectric conversion device 100 and is used to determine whether omissions in counting on the blinking light source have occurred. The signal processing unit 804 may perform processing such as black level correction, gamma curve adjustment, noise reduction, and data compression, in addition to correction of omissions in counting. The photoelectric conversion device 100 includes an on-chip color filter. If the photoelectric conversion device 100 is capable of obtaining color information, the photoelectric conversion device 100 may perform processing such as white balance correction and color conversion.

The control unit 801 incorporates a central processing unit (CPU) serving as a computer, and functions as a control unit for controlling the operation of each unit in the entire photoelectric conversion system 800 based on control programs stored in a memory serving as a storage medium. Further, the control unit 801 controls the length of the exposure period of each frame of the photoelectric conversion device 100, the timings of the control signal CLK1 and the control signal CLK2, and the like through the control pulse generation unit 115 of the photoelectric conversion device 100. Further, the control unit 801 functions as a determination unit for determining non-uniformity of photons incident on the photoelectric conversion device 100. Any one of the determination methods according to the first to fourth embodiments may be employed as the determination method.

The storage unit 802 includes, for example, a recording medium such as a memory card, a hard disk, or the like. The communication unit 803 includes a wireless interface or a wired interface, outputs the generated image to the outside of the photoelectric conversion system 800, and receives signals from the outside.

### Other Embodiments

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-081727, filed May. 15, 2025, which is hereby incorporated by reference herein in its entirety.

What is claimed is:

1. A device comprising:
a conversion unit configured to generate a detection signal by avalanche multiplication, an exposure period corresponding to one frame in the conversion unit including a plurality of detection periods for outputting a signal based on the detection signal, each of the plurality of detection periods including a first period and a second period, the second period being a period that is subsequent to the first period and does not overlap the first period;
a count circuit configured to count first signals based on the detection signal during the first period and to count second signals based on the detection signal during the second period;
at least one memory storing instructions; and
at least one processor that executes the stored instructions that cause the at least one processor to determine non-uniformity of photons incident on the conversion unit based on a distribution of count values of the first signals counted during the first period and the second signals counted during the second period.

2. The device according to claim 1, wherein the instructions cause the at least one processor to determine non-uniformity of photons incident on the conversion unit based on non-uniformity in a distribution of the first signals and the second signals during the exposure period.

3. The device according to claim 2, wherein the instructions cause the at least one processor to determine non-uniformity of photons incident on the conversion unit based on a comparison between the count value of the first signals and the count value of the second signals.

4. The device according to claim 1, wherein the instructions cause the at least one processor to determine that photons are not uniformly incident on the conversion unit in a case where a difference between the count value of the first signals and the count value of the second signals is less than a predetermined threshold.

5. The device according to claim 1, wherein the instructions cause the at least one processor to determine that photons are uniformly incident on the conversion unit in a case where a difference between the count value of the first signals and the count value of the second signals is more than or equal to a predetermined threshold.

6. The device according to claim 1, wherein the instructions cause the at least one processor to determine non-uniformity of photons incident on the conversion unit based on a comparison between the count value of the first signals and the number of the detection periods in the exposure period.

7. The device according to claim 6, wherein the instructions cause the at least one processor to obtain the count value of the second signals based on a difference between the count value of the first signals and the number of the detection periods.

8. The device according to claim 1,
wherein the count circuit counts the first signals and the second signals in a plurality of exposure periods in the conversion unit, and
wherein the instructions cause the at least one processor to determine non-uniformity of photons incident on the conversion unit based on the count value of the first signals counted in each of the plurality of exposure periods and the count value of the second signals counted in each of the plurality of exposure periods.

9. The device according to claim 8, wherein the instructions cause the at least one processor to determine that photons are uniformly incident on the conversion unit in a case where a difference between the count value of the first signals and the count value of the second signals counted in at least one of the plurality of exposure periods is more than or equal to a predetermined threshold.

10. The device according to claim 8, wherein the instructions cause the at least one processor to determine that photons are not uniformly incident on the conversion unit in a case where a difference between the count value of the first signals and the count value of the second signals counted in at least one of the plurality of exposure periods is more than or equal to a predetermined threshold.

11. The device according to claim 1,
wherein the count circuit includes a first count circuit and a second count circuit,
wherein the first count circuit outputs a first count value of the first signals counted during the first period,
wherein the second count circuit counts signals based on the detection signal during the second period in each of the plurality of detection periods and outputs a second count value, and
wherein the instructions cause the at least one processor to determine non-uniformity of photons incident on the conversion unit based on a distribution of the first count value and the second count value.

12. A system comprising:
a device according to claim 1; and
a signal processing unit configured to generate an image using a signal output from the device.

13. The system according to claim 12, wherein, in the device, the instructions cause the at least one processor to determine non-uniformity of photons incident on the conversion unit based on non-uniformity in a distribution of the first signals and the second signals during the exposure period or based on a comparison between the count value of the first signals and the count value of the second signals.

14. The system according to claim 12, wherein, in the device, the instructions cause the at least one processor to determine that photons are not uniformly incident on the conversion unit in a case where a difference between the count value of the first signals and the count value of the second signals is less than a predetermined threshold.

15. The system according to claim 12, wherein, in the device, the instructions cause the at least one processor to determine that photons are uniformly incident on the conversion unit in a case where a difference between the count value of the first signals and the count value of the second signals is more than or equal to a predetermined threshold.

16. The system according to claim 12, wherein, in the device, the instructions cause the at least one processor to determine non-uniformity of photons incident on the conversion unit based on a comparison between the count value of the first signals and the number of the detection periods in the exposure period.

17. The system according to claim 16, wherein the instructions cause the at least one processor to obtain the count value of the second signals based on a difference between the count value of the first signals and the number of the detection periods.

18. The system according to claim 12,
wherein, in the device, the count circuit counts the first signals and the second signals in a plurality of exposure periods in the conversion unit, and
wherein, in the device, the instructions cause the at least one processor to determine non-uniformity of photons incident on the conversion unit based on the count value of the first signals counted in each of the plurality of exposure periods and the count value of the second signals counted in each of the plurality of exposure periods.

19. The system according to claim 18, wherein, in the device the instructions cause the at least one processor to determine that (i) photons are uniformly incident on the conversion unit in a case where a difference between the count value of the first signals and the count value of the second signals counted in at least one of the plurality of exposure periods is more than or equal to a predetermined threshold or (ii) photons are not uniformly incident on the conversion unit in a case where a difference between the count value of the first signals and the count value of the second signals counted in at least one of the plurality of exposure periods is more than or equal to a predetermined threshold.

20. The system according to claim 12,
wherein, in the device,
the count circuit includes a first count circuit and a second count circuit,
the first count circuit outputs a first count value of the first signals counted during the first period,
the second count circuit counts signals based on the detection signal during the second period in each of the plurality of detection periods and outputs a second count value, and
the instructions cause the at least one processor to determine non-uniformity of photons incident on the conversion unit based on a distribution of the first count value and the second count value.
